(19) United States
(12) Patent Application Publication
(10) Pub. No.: US 2016/0100360 A1
(43) Pub. Date: Apr. 7, 2016

(54) METHODS AND APPARATUS FOR USING ENHANCEMENTS FOR DIVERSE DATA APPLICATIONS (EDDA)/POWER PREFERENCE INDICATION (PPI)

(71) Applicant: QUALCOMM Incorporated, San Diego, CA (US)

(72) Inventors: Feilu LIU, San Diego, CA (US); Aziz GHOLMIEH, San Diego, CA (US); Niranjan Ramesh PENDHARKAR, San Diego, CA (US); Arun Prasanth BALASUBRAMANIAN, Hyderabad (IN); Daniel AMERGA, San Diego, CA (US)

(21) Appl. No.: 14/861,700

(22) Filed: Sep. 22, 2015

(30) Foreign Application Priority Data
Oct. 7, 2014 (IN) 3163/MUM/2014

(51) Int. Cl. H04W 52/02; H04W 72/12

(52) U.S. Cl. CPC H04W 52/028; H04W 72/1284

(57) ABSTRACT

Aspects of the present disclosure provide apparatus and techniques for determining one or more operating conditions related to a UE and transmitting a power preference indication (PPI) to an cNB based, at least in part, on the determination. The one or more operating conditions may be related to at least one of a throughput, battery configuration, application data history, or temperature of the UE. In response to the determination, the UE may transmit one of a PPI that is set to or indicates normal power mode or a PPI that is set to low power mode, for example. Additionally, the UE may decide whether or not to delay sending a scheduling request (SR) to the eNB based, at least in part, on the determination.

### CROSS-REFERENCE TO RELATED APPLICATIONS UNDER 35 U.S.C. §119

This application claims priority to Indian Provisional Patent Application No. 3163/MUM/2014, filed Oct. 7, 2014, entitled “METHODS AND APPARATUS FOR USING ENHANCEMENTS FOR DIVERSE DATA APPLICATIONS (cDDA)/POWER PREFERENCE INDICATION (PPI),” which is hereby expressly incorporated by reference herein.

### FIELD

The present disclosure relates generally to communication systems, and more particularly, to techniques and apparatus for transmitting a determined power preference indication (PPI) to an evolved Node B (eNB).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communication by a user equipment (UE). The method generally includes determining one or more operating conditions related to at least one of a throughput, battery configuration, application data history, or temperature of the UE and transmitting a power preference indication (PPI) to an evolved Node B (eNB) based, at least in part, on the determination.

Certain aspects of the present disclosure provide an apparatus for wireless communication by a user equipment (UE). The apparatus generally includes means for determining one or more operating conditions related to at least one of a throughput, battery configuration, application data history, or temperature of the UE and means for transmitting a power preference indication (PPI) to an evolved Node B (eNB) based, at least in part, on the determination.

Certain aspects of the present disclosure provide an apparatus for wireless communication by a user equipment (UE). The apparatus generally includes a transmitter, at least one processor, and a memory coupled to the at least one processor. The at least one processor configured to determine one or more operating conditions related to at least one of a throughput, battery configuration, application data history, or temperature of the UE and the transmitter is configured to transmit a power preference indication (PPI) to an evolved Node B (eNB) based, at least in part, on the determination.

Certain aspects of the present disclosure provide a computer-readable medium for wireless communication by a user equipment (UE). The computer-readable medium has one or more instructions stored thereon. The one or more instructions executable by one or more processors for determining one or more operating conditions related to at least one of a throughput, battery configuration, application data history, or temperature of the UE and for transmitting a power preference indication (PPI) to an evolved Node B (eNB) based, at least in part, on the determination.

Aspects generally include methods, apparatus, systems, computer program products, and processing systems, as substantially described herein with reference to and as illustrated by the accompanying drawings.

### BRIEF DESCRIPTION OF THE DRAWINGS

FIG. 1 is a diagram illustrating an example of a network architecture, in accordance with certain aspects of the disclosure.

FIG. 2 is a diagram illustrating an example of an access network, in accordance with certain aspects of the disclosure

FIG. 3 is a diagram illustrating an example of a DL frame structure in LTE, in accordance with certain aspects of the disclosure.

FIG. 4 is a diagram illustrating an example of an UL frame structure in LTE, in accordance with certain aspects of the disclosure.

FIG. 5 is a diagram illustrating an example of a radio protocol architecture for the user and control plane, in accordance with certain aspects of the disclosure.

FIG. 6 is a diagram illustrating an example of an evolved Node B (eNB) and user equipment (UE) in an access network, in accordance with certain aspects of the disclosure.

FIG. 7 illustrates example procedure for configuring PPI, in accordance with certain aspects of the present disclosure.

FIG. 8 shows a flow diagram illustrating operations performed by a UE for transmitting a PPI, in accordance with certain aspects of the present disclosure.

### DETAILED DESCRIPTION

Aspects of the present disclosure provide techniques and apparatus for determining one or more operating conditions related to a UE and transmitting a power preference indication (PPI) to an eNB based, at least in part, on the determination. As will be described in more detail herein, the one or more operating conditions may be related to at least one of a throughput, power, battery configuration, application activity, application data history, or temperature of the UE. In response to the determination, the UE may transmit one of a PPI that is set to or indicates normal power or a PPI that is set to low power. According to aspects, the UE may decide whether or not to delay sending a scheduling request (SR) to an eNB based, at least in part, on the determination.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

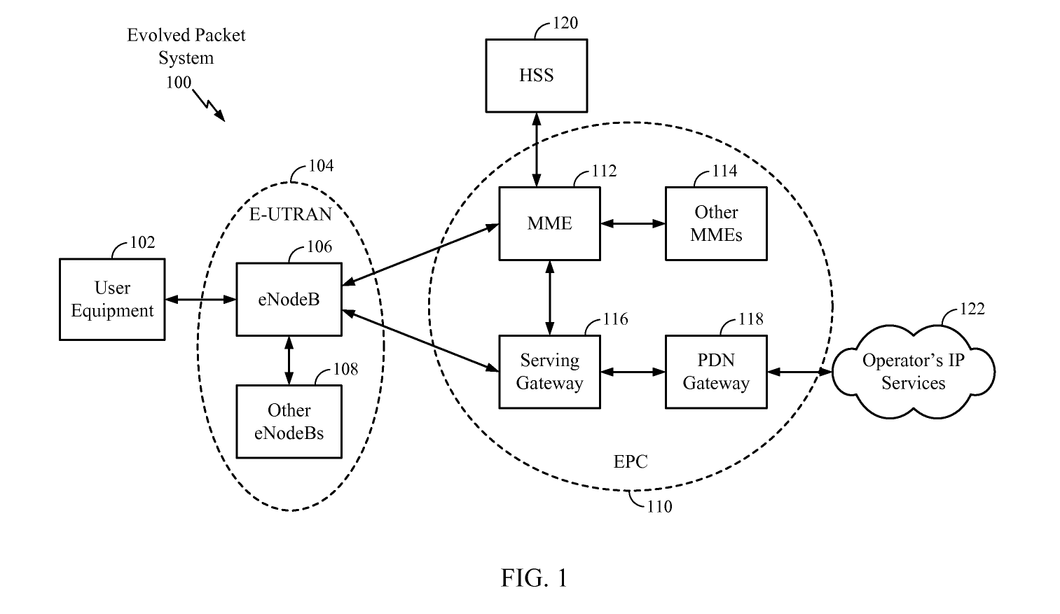

FIG. 1 is a diagram illustrating an example wireless communication network 100 (e.g., an LTE network), in which the techniques described herein may be practiced. For example, the UE 102 may identify conditions for reporting a power preference indication (PPI) the eNB 106. As will be described in more detail herein, the UE, may determine one or more operating conditions related to at least one of a throughput, power, battery configuration, application activity, application data history, or temperature of the UE and the UE may transmit a PPI based, at least in part on the determination. Additionally, according to aspects, the UE may decide whether or not to delay sending a SR to the eNB based, at least in part, on the determination.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS Streaming Service (PSS). In this manner, the UE102 may be coupled to the PDN through the LTE network.

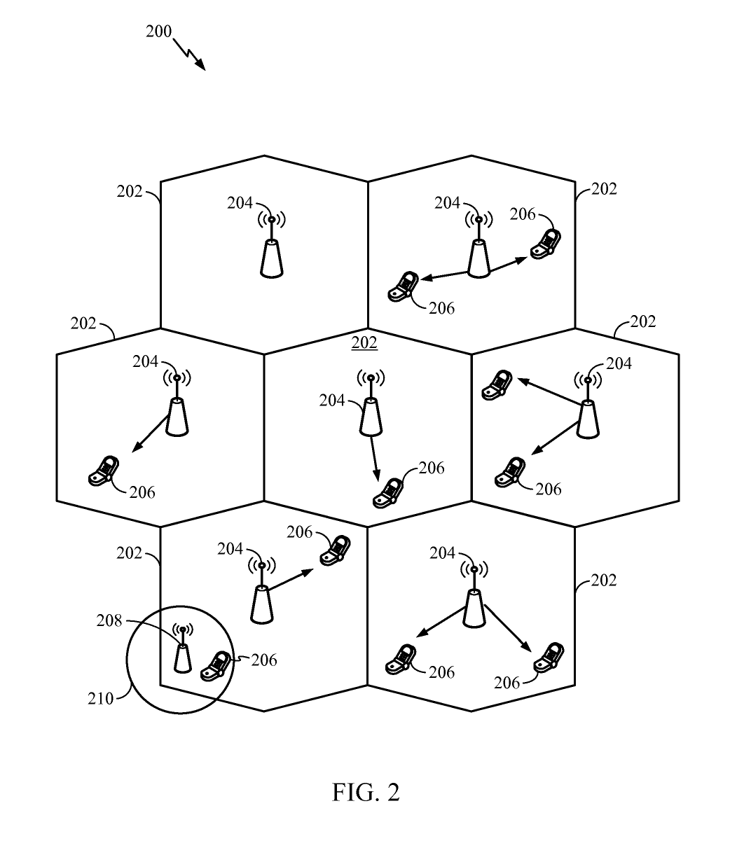

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The cNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

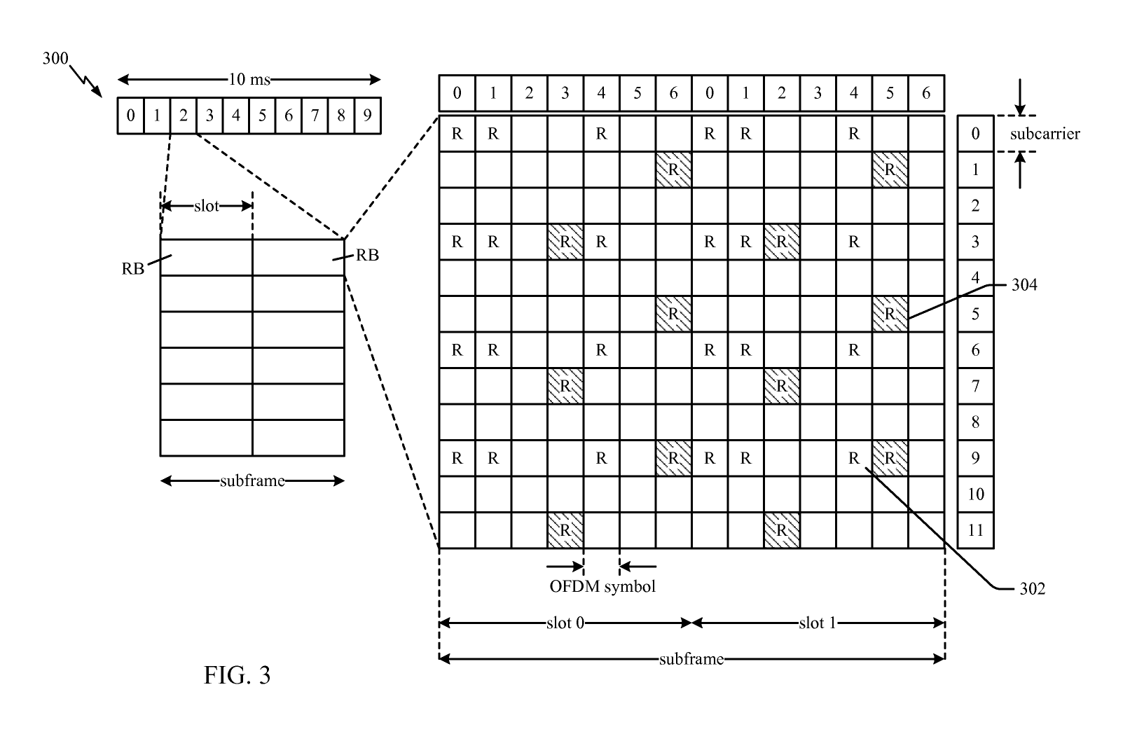

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

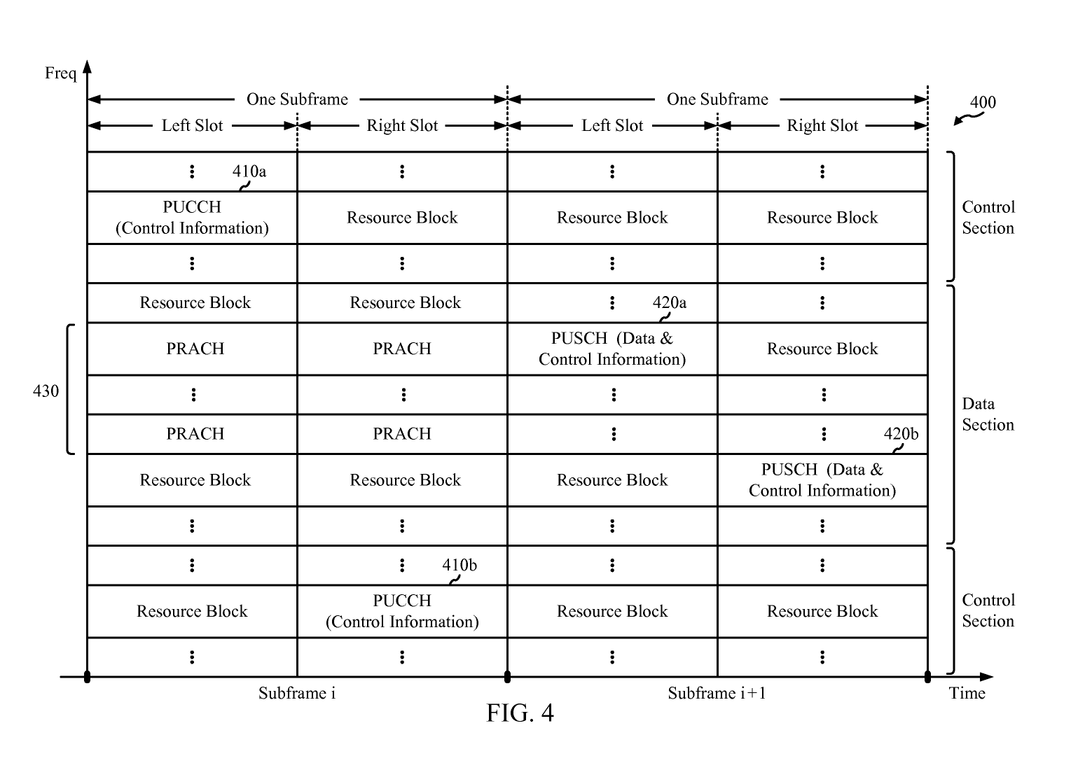

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an cNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

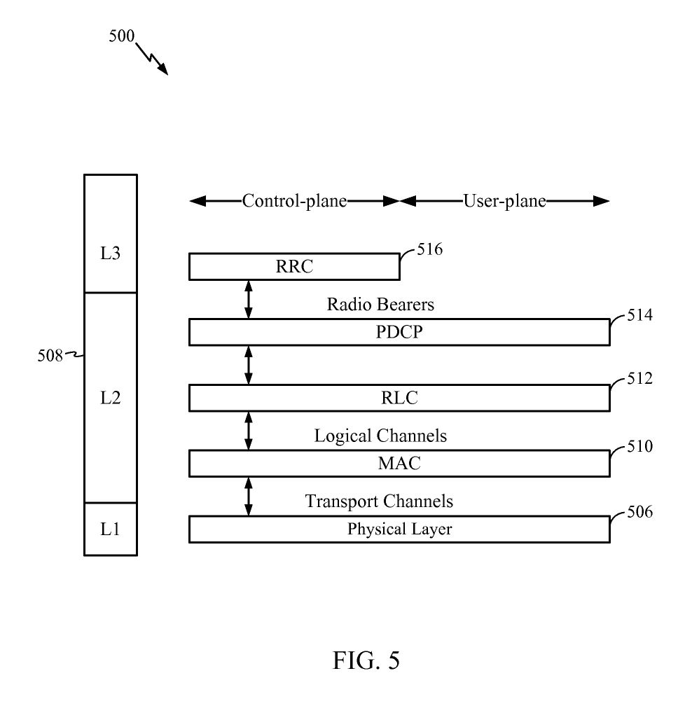

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

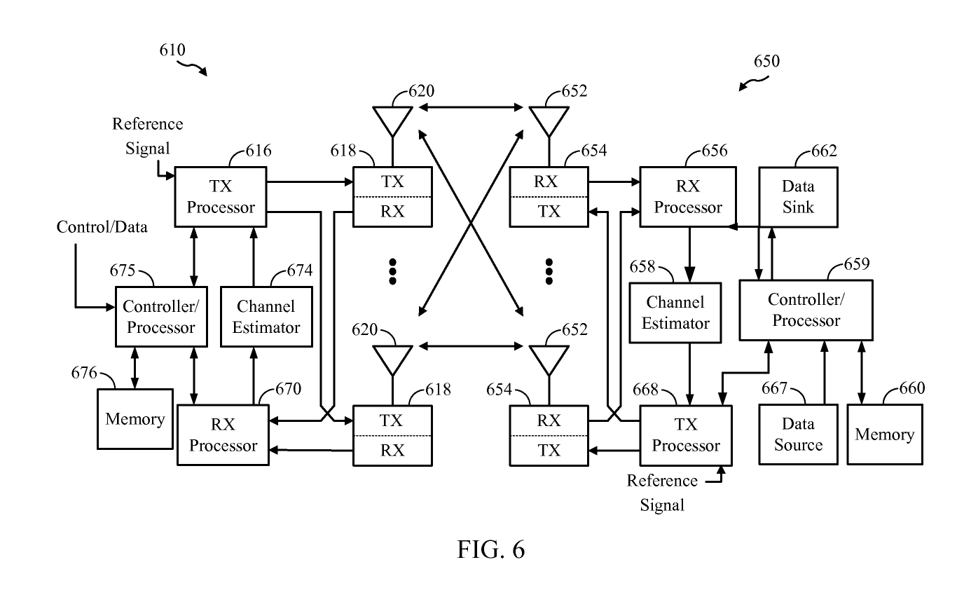

FIG. 6 is a block diagram of an eNB 610 in communication with a UE 650 in an access network in accordance with aspects of the present disclosure. The UE 102 of FIG. 1 may include one or more components as illustrated in FIG. 6. Similarly, the eNBs 106, 108 of FIG. 1 may include one or more components of eNB 610 as illustrated in FIG. 6.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

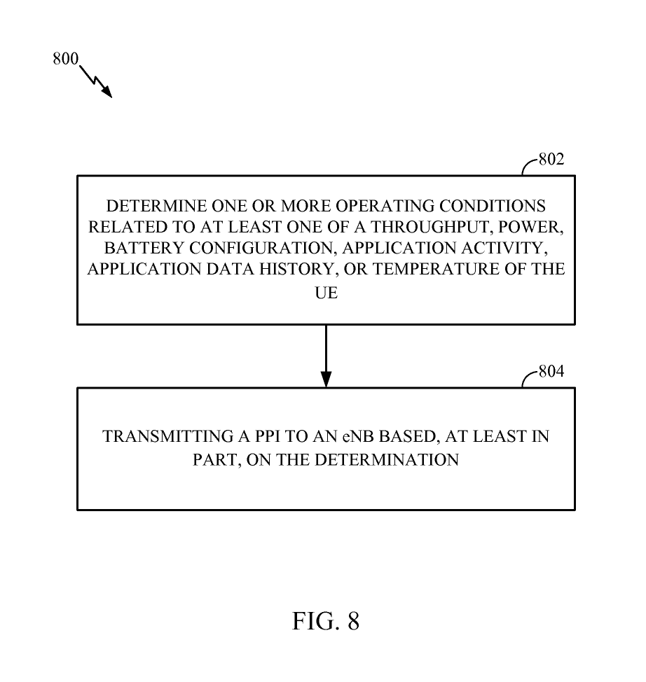

The controllers/processors 675, 659 may direct the operation at the eNB 610 and the UE 650, respectively. The controller/processor 659 and/or other processors and modules at the UE 650 may perform or direct operations for example operations 800 in FIG. 8, and/or other processes for the techniques described herein, for example. The controller/processor 675 and/or other processors and modules at the eNB 610 may perform or direct operations and/or other processes for the techniques described herein. In aspects, one or more of any of the components shown in FIG. 6 may be employed to perform example operations 800 and/or other processes for the techniques described herein. For example, the controller/processor and or any other processor module may determine one or more operating conditions related to at least one of a throughput, power, battery configuration, application activity, application data history, or temperature of the UE. The controller/processor may be coupled to at least one memory 660 having instructions stored thereon. The transmitter 654 and antenna 652 may transmit the PPI to the eNB.

### Example Methods and Apparatus for Using eDDA/PPI

A power saving feature, enhanced Diverse Data Applications (eDDA), was introduced in LTE Release 11. According to eDDA, a power preference indication (PPI) is transmitted by the UE to the network (e.g., eNB) to indicate the UE's preference of power consumption. The PPI conveys to an eNB, via 1 bit, the UE's preference for normal power (e.g., operating in a normal power mode during which normal power is consumed) (e.g., PPI set to normal) or low power (e.g., operating in a low power mode during which low power is consumed) (e.g., PPI set to low power). In aspects, operating in a normal power mode may include operating in a mode other than one in which low power is consumed. For example, operating in a normal power mode may include operating in a mode in which high power is consumed.

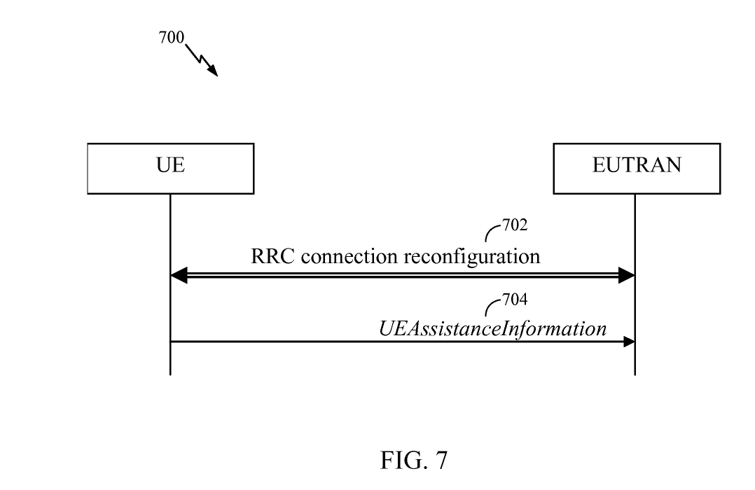

FIG. 7 illustrates an example procedure 700 for configuring a PPI, according to aspects of the present disclosure. At 702, the UE may be configured to provide PPIs to an eNB of the EUTRAN. At 704, the UE may transmit message UEAssistanceInformation, which may include providing the eNB with a PPI. The UE may transmit a PPI, for example, upon change of power preference. As will be described in more detail herein, the UE may set the contents of the UEAssistanceInformation based on the its preferred power saving. For example, if the UE prefers a configuration for power saving, it may set a powerPrefIndication to a lowPowerConsumption Indication. If the UE prefers a configuration for normal power, it may transmit a powerPrefIndication set to normalPowerConsumption. In aspects, such PPI configuration may affect configuration of one or more of the following, (1) OtherConfig information element which includes parameter powerPrefIndicationTimer that configures a prohibit timer for Power Preference Indication reporting; (2) UE-EUTRA-Capability information element which includes powerPrefInd that indicates whether the UE supports power preference indication; and (3) IE AS-Context is used to transfer local E-UTRAN context required by the target eNB, for example.

In an effort to save power at a UE and network resources, it may be desirable to identify triggers and/or scenarios for a UE to report a particular PPI. For example, it may be beneficial to determine triggers and/or scenarios for reporting a PPI that is set to or indicates low power and/or for reporting a PPI that is set to or indicates normal power. Aspects of the present disclosure provide techniques and apparatus for determining one or more operating conditions related to, for example, at least one of a throughput of a UE, power, battery configuration, application activity, application data history, or temperature of the UE and transmitting a PPI to an eNB based, at least in part, on the determination.

As described above, for example, with reference FIG. 4, LTE has DL control channels (e.g., PDCCH), UL control channels (e.g., PUCCH), DL data channels (e.g., PDSCH), and UL data channels (e.g., PUSCH). Further, LTE operations may be organized in non-overlapping periods of milliseconds in time, wherein 1 millisecond comprises a subframe. In this manner, UL and DL data channels are divided into blocks of time.

Further, UL and DL data channels are divided into blocks of frequency. For example UL and DL data channels are divided into non-overlapping bandwidths, (e.g., each bandwidth being 180 KHz). Thus, an assignment of an DL (or UL) resource block to a UE means the UE may use a particular 180 KHz BW for a 1 millisecond subframe for DL (or UL) transmission.

In each subframe, an eNB transmits, via the PDCCH, scheduling grants for DL and UL. A grant has at least the following information: a UE's Radio Network Temporary Identifier (RNTI) identifying the UE, resource block (RB) locations identifying which 180 KHz BW to use (and for UL the RB locations inform the UE of the subframes on which it should transmit), and modulation and coding scheme conveying how the signal is constructed within the RBs, for example.

A grant may include information regarding multiple RBs. Multiple grants, non-overlapping in frequency, may be assigned to multiple UEs in one subframe. If DL RBs are granted, the UE may look to the PDSCH to receive its data in the same subframe. If UL RBs are granted, the UE may transmit data on the PUSCH in the subframe specified in the grant.

FIG. 8 illustrates example operations 800, performed by a UE, according to aspects of the present disclosure. According to aspects, the UE may include one or more components of the UE 650 illustrated in FIG. 6. For example, antenna 652, Tx/Rx 654, RX processor 656, controller/processor 659, and/or TX processor 668 may perform the operations described herein. Further, memory 660 may store programmable instructions implemented by one or more components of the UE 650.

At 802, the UE may determine one or more operating conditions related to at least one of a throughput, power, battery configuration, application activity, application data history, or temperature of the UE. At 804, the UE may transmit a PPI to an eNB based, at least in part, on the determination. According to aspects, at least one or more operating conditions may be known by the eNB and the UE. As described below, at least one of the one or more operating conditions may be determined by the UE. The transmitted PPI may include a transmission of a PPI that is set to or indicates normal power or a PPI that is set to or indicates low power.

### PPI Set to Normal Power

According to aspects, the UE may report a PPI that is set to or indicates normal power when a throughput of the UE passes a first threshold. The determined throughput may relate to any protocol layer (e.g., application layer, IP layer, and/or another layer defined by 3GPP).

To determine throughput, the UE may average over time, the total number of bits received and/or transmitted. The throughput may pass a first threshold when at least one of an UL throughput of the UE passes a threshold for UL throughput, a DL throughput of the UE passes a threshold for DL throughput, or a total DL and UL throughput of the UE passes a total throughput threshold. Additionally or alternatively, a UE may determine that the throughput of the UE passes the first threshold based on a data history of an application in use by the UE.

Additionally or alternatively, according to aspects, the UE may report a PPI that is set to or indicates normal power when an average number of scheduled resource blocks (RBs) per subframe of the UE passes a second threshold. For example, the average number of scheduled RBs per subframe may pass the second threshold when at least one of a number of scheduled UL RBs per subframe of the UE passes a threshold for scheduled UL RBs per subframe, a number of scheduled DL RBs per subframe of the UE passes a threshold for scheduled DL RBs per subframe, or a total number of scheduled UL and DL RBs per subframe of the UE passes a total threshold for scheduled RBs.

Additionally or alternatively, according to aspects, the UE may report a PPI that is set to or indicates normal power when a percentage of time the UE is scheduled passes a third threshold. The percentage of time the UE is scheduled may pass the third threshold when at least one of a percentage of time the UE is scheduled for receiving UL transmissions passes a threshold for UL scheduling, a percentage of time the UE is scheduled for transmitting DL transmissions passes a threshold for DL scheduling, or a total percentage of time the UE is scheduled for UL and DL transmissions passes a total percentage of time threshold.

Additionally or alternatively, according to aspects, the UE may report a PPI that is set to or indicates normal power when a user is interacting with the UE. A user may be interacting when at least one of the UE is moving and/or rotating, when the UE's screen is unlocked (e.g., when the screen is on), when the user is typing or entering information into the UE, the user is performing voice control of the UE, or the UE is streaming audio (e.g., sound or music) to a speaker (e.g., speaker internal or external to the UE).

Additionally or alternatively, according to aspects, the UE may report a PPI that is set to normal when a remaining battery level of the UE passes a fourth threshold. The fourth threshold may be measured in units of power (e.g., mA*hour).

Additionally or alternatively, according to aspects, the UE may determine that a user application (e.g., in an active or foreground state) may use and/or benefit from a higher throughput. For example, using the application's data history, the UE may dynamically learn or infer that the particular application or application type may benefit from a higher throughput. According to aspects, the UE may report a PPI that is set to normal upon this determination and/or inference.

Additionally or alternatively, according to aspects, the UE may report a PPI that is set to or indicates normal power based on a current battery configuration, for example, when the UE is coupled to or connected to a power source. Further, the UE may report a PPI that is set to or indicates normal power when the UE is coupled to or connected to a power source and not equipped with a battery. Further, the UE may report a PPI that is set to or indicates normal power when the UE is coupled to or connected to a power source and the remaining battery level is above a fifth threshold.

Additionally or alternatively, according to aspects, the UE may report a PPI that is set to or indicates normal power when an uplink transmission buffer size is greater than a sixth threshold. The uplink transmission buffer may be related to any protocol layer of the UE (e.g., application layer, IP layer, and/or any layer defined by 3GPP) and may indicate the size of the queue of bits to be transmitted by the UE.

Additionally or alternatively, according to aspects, the UE may report a PPI that is set to or indicates normal power when the temperature (e.g., thermal temperature) of the UE is less than a seventh threshold. In an effort to avoid burning the UE, the UE may not signal a PPI indicating normal power when the UE has a increased temperature, for example when the UE is under sunlight. In such a scenario, the UE may report a PPI that is set to or indicates a low power.

According to aspects, a UE may determine to report a PPI that is set to or indicates normal power based on a throughput-based, power supply-based, and/or user activity-based implementation, a temperature of the UE, or a combination thereof. These implementations may use one or more conditions described above.

For example, a throughput-based implementation may use conditions related to the throughput of any protocol layer exceeding a threshold, the average number of RBs scheduled per subframe exceeding a threshold, the percentage of time the UE is scheduled exceeding a threshold, the uplink buffer size exceeding a threshold and/or any parameter related to the UE's throughput. A power supply-based implementation may use conditions related to the UE being charged or coupled or connected to a power line and not equipped with a battery, the UE being charged or coupled or connected to a power line and the remaining capacity being above a threshold, and/or any parameter related to the UE's power. A user activity-based implementation may use conditions related to a user interacting with the UE (e.g., via the UE's screen), a remaining battery level capacity being above a threshold, a type of active or foreground user application, and/or any parameter related to user activity associated with the UE.

Upon receiving a PPI set to or indicating normal power, the eNB may update throughput (e.g., grant the UE as much throughput as the eNB can). The eNB may update (e.g., grant additional) throughput using one or more of the following techniques.

The eNB may configure and activate carrier aggregation (CA) for multiple cells in UL or DL. The eNB may reconfigure discontinuous reception (DRX) parameters. Reconfiguring DRX parameters, upon receiving the PPI set to or indicating normal power, may include disabling DRX, such that the UE does not go sleep, setting a larger “on” duration timer or a smaller inactivity timer, such that the UE is awake for a longer amount of time in each DRX cycle, and/or decreasing the DRX cycle in a effort to configure the UE to wake up more frequently.

Additionally or alternatively, the eNB may update throughput by configuring and activating dual connectivity.

Additionally or alternatively, the eNB may configure the UE to measure fewer inter-frequency or inter-Radio Access Technology (RAT) neighbor frequencies and cells. The eNB may configure the UE to take such measurements less frequently, in an effort to provide the UE with increased throughput.

Additionally or alternatively, the eNB may disable minimization of drive tests (MDT) configurations or make drive tests less frequent such that the UE may not need to measure surrounding cells as frequently.

### PPI Set to Low Power

According to aspects, the UE may determine that one or more operating conditions does not pass a threshold and may transmit a PPI set to or indicating low power to the eNB.

For example, the UE may determine that one or more operating conditions do not pass a threshold if data throughput of the UE does not pass a threshold based on a data history of an application used by the UE. For example, the UE may infer that an ongoing gaming and/or enhanced Multimedia Broadcast Multicast Services (eMBMS) applications may not require a dedicated, unicast radio channel.

Additionally or alternatively, complementary to the triggers described above for reporting a PPI set to normal, the UE may transmit a PPI set to or indicating low power upon determining at least one of a throughput of any protocol layer of the UE does not pass a first threshold, an average number of scheduled RBs per subframe of the UE does not pass a second threshold, a percentage of time the UE is scheduled does not pass a third threshold, a user is not interacting with the UE, a remaining battery level of the UE does not pass a fourth threshold, the application data history (e.g., dynamically learned and/or dynamically determined by the UE) indicates that the active or foreground user application may not use a high throughput, the UE is not coupled or connected to a power source and the remaining battery capacity is not above a fifth threshold, the uplink transmission buffer size is not greater than a sixth threshold, and/or the thermal temperature of the UE is not greater than a seventh threshold.

In response to transmitting the PPI set to or indicating low power, the UE may receive one or more messages from the eNB causing the UE to enable one or more features to reduce power consumption and/or disable one or more features to reduce power consumption.

For example, in response to receiving a PPI set to or indicating low power, the eNB may determine that data activity between the eNB and UE is occurring. In this case, the eNB may instruct the UE to take action in an effort to meet a minimum quality of service (QoS). If there is no data activity between the eNB and UE, the eNB may instruct the UE to save power (e.g., save as much power as possible). This may be done, for example, by deactivating dual connectivity, reconfiguring DRX parameters such that the DRX is enabled, making a UE wakeup time shorter, for example by setting a shorter “on” duration timer or a larger inactivity timer, and/or setting a longer DRX cycle such that the UE wakes up less frequently.

Similar to the description above with respect to a PPI set to or indicating normal power, in response to a PPI set to or indicating low power, the eNB may configure the UE to measure fewer inter-frequency or inter-RAT neighbor frequencies and cells, configure the UE to take such measurements less frequently and/or disable minimization of drive tests (MDT) configurations or make drive tests less frequent such that the UE may not need to frequently measure surrounding cells. These actions may be performed in an effort to save power (e.g., in response to a PPI indication set to or indicating low power) and/or may be performed in an effort to boost throughput (e.g., in response to a PPI indication set to or indicating normal power).

The numerous triggers and scenarios described herein may be used in isolation or in combination to determine one or more conditions related to a UE's power preference. Accordingly, any combination of conditions known by the UE and eNB, and/or determined by the UE may be used to determine a PPI to transmit to the eNB. Additionally or alternatively, any combination of conditions related to at least one of throughput, power, battery configuration, application data history, or application activity of the UE may be used to determine the power preference.

### Classify Traffic Based on User Interactions

At the MAC layer, data bearers are treated with different priorities. Each priority of data bearer may use a separate transmission buffer. For UL transmission, the UE may report a buffer state for each of the separate transmission buffers. To make an uplink transmission, the UE may transmit a scheduling request (SR) to the eNB which may be based on the buffer status of each of the transmission buffers. Additionally, for high priority bearers, the SR may be transmitted shortly after data arrival at the high-priority transmission buffer. For lower-priority bearers, the SR may be delayed (e.g., statistically or deterministically). A data bearer identifies or associates a data stream with a quality of service and other properties.

Currently, the network may assign a static priority per data bearer and the UE may select a bearer based on the QoS the application requires. Accordingly traffic may be mapped to a “best effort” class and may be multiplexed with data on the same bearer. An increased differentiation of traffic may exists when Voice over LTE (VoLTE) is introduced

Aspects of the present disclosure provide techniques for a UE to determine the priority of each bearer in an effort to determine whether or not transmission of an SR may or may not be delayed.

For example, the UE may classify traffic differently based on user interactions. User interactions, as described herein, refer not only to the last used application, but may also refer to the last N used applications. Additionally, if a user interactions with an application T seconds ago and stopped interacting thereafter, the UE may still consider the user to be interacting.

Therefore, the UE may decide whether or not to delay transmitting a SR to an eNB based, at least in part, on a determined PPI. In this manner, the UE may delay a SR based on trigger conditions for a PPI set to or indicating low power. When trigger conditions for a PPI set to or indicating normal power are met, the UE may not delay the SR. In certain scenarios, the UE may immediately transmit the SR when trigger conditions for a PPI set to or indicating normal power are met.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for wireless communication by a user equipment (UE), comprising:
determining one or more operating conditions related to at least one of a throughput, battery configuration, application data history, or temperature of the UE; and
transmitting a power preference indication (PPI) to an evolved Node B (eNB) based, at least in part, on the determination.

2. The method of claim 1, wherein the at least one of the one or more operating conditions are known by the eNB and the UE.

3. The method of claim 1, wherein the at least one of the one or more operating conditions are determined by the UE.

4. The method of claim 1, wherein the one or more operating conditions are based on at least one of: user activity of the UE or data transfer between the UE and the eNB.

5. The method of claim 1,
wherein determining the one or more operating conditions comprises determining at least one of: a throughput of the UE passes a first threshold, an average number of scheduled resource blocks (RBs) per subframe of the UE passes a second threshold, a percentage of time the UE is scheduled passes a third threshold, application data history of the UE passes a fourth threshold, the UE is coupled to a power source and not equipped with a battery, an uplink transmission buffer size of the UE passes a fifth threshold, or the temperature of the UE is less than a sixth threshold; and
wherein transmitting the PPI comprises transmitting a PPI that is set to or indicates normal power mode.

6. The method of claim 1, further comprising:
determining the one or more operating conditions does not pass a threshold; and
wherein transmitting the PPI comprises transmitting a PPI that is set to or indicates low power mode.

7. The method of claim 6, further comprising receiving one or more messages causing the UE to at least one of:
enable one or more features to reduce power consumption; or
disable one or more features to reduce power consumption.

8. The method of claim 1, further comprising:
determining the one or more operating conditions pass a threshold; and
wherein transmitting the PPI comprises transmitting a PPI that is set to or indicates normal power mode.

9. The method of claim 8, further comprising receiving one or more messages causing the UE to at least one of:
enable one or more features to increase power consumption; or
disable one or more features to increase power consumption.

10. The method of claim 1, wherein the transmitted PPI includes at least one of a PPI that is set to or indicates normal power mode or a PPI that is set to or indicates low power mode.

11. The method of claim 1, further comprising:
deciding whether or not to delay sending a scheduling request (SR) to the eNB based, at least in part, on the determination.

12. An apparatus for wireless communication by a user equipment (UE), comprising:
means for determining one or more operating conditions related to at least one of a throughput, battery configuration, application data history, or temperature of the UE; and
means for transmitting a power preference indication (PPI) to an evolved Node B (eNB) based, at least in part, on the determination.

13. The apparatus of claim 12, wherein the at least one of the one or more operating conditions are known by the eNB and the UE.

14. The apparatus of claim 12, wherein the at least one of the one or more operating conditions are determined by the UE.

15. The apparatus of claim 12, wherein the one or more operating conditions are based on at least one of: user activity of the UE or data transfer between the UE and the eNB.

16. The apparatus of claim 12,
wherein the means for determining the one or more operating conditions comprises means for determining at least one of: a throughput of the UE passes a first threshold, an average number of scheduled resource blocks (RBs) per subframe of the UE passes a second threshold, a percentage of time the UE is scheduled passes a third threshold, application data history of the UE passes a fourth threshold, the UE is coupled to a power source and not equipped with a battery, an uplink transmission buffer size of the UE passes a fifth threshold, or the temperature of the UE is less than a sixth threshold; and
wherein the means for transmitting the PPI comprises means for transmitting a PPI that is set to or indicates normal power mode.

17. The apparatus of claim 12, further comprising:
means for determining the one or more operating conditions does not pass a threshold; and
wherein the means for transmitting the PPI comprises means for transmitting a PPI that is set to or indicates low power mode.

18. The apparatus of claim 17, further comprising means for receiving one or more messages causing the UE to at least one of:
enable one or more features to reduce power consumption; or
disable one or more features to reduce power consumption.

19. The apparatus of claim 12, further comprising:
means for determining the one or more operating conditions pass a threshold; and
wherein the means for transmitting the PPI comprises means for transmitting a PPI that is set to or indicates normal power mode.

20. The apparatus of claim 19, further comprising means for receiving one or more messages causing the UE to at least one of:
enable one or more features to increase power consumption; or
disable one or more features to increase power consumption.

21. The apparatus of claim 12, wherein the transmitted PPI includes at least one of a PPI that is set to or indicates normal power mode or a PPI that is set to or indicates low power mode.

22. The apparatus of claim 12, further comprising:
means for deciding whether or not to delay sending a scheduling request (SR) to the eNB based, at least in part, on the determination.

23. An apparatus for wireless communication by a user equipment (UE), comprising:
at least one processor configured to determine one or more operating conditions related to at least one of a throughput, battery configuration, application data history, or temperature of the UE;
a transmitter configured to transmit a power preference indication (PPI) to an evolved Node B (eNB) based, at least in part, on the determination; and
a memory operably coupled to the at least one processor.

24. The apparatus of claim 23,
wherein the at least one processor is configured to determine the one or more operating conditions by determining at least one of: a throughput of the UE passes a first threshold, an average number of scheduled resource blocks (RBs) per subframe of the UE passes a second threshold, a percentage of time the UE is scheduled passes a third threshold, application data history of the UE passes a fourth threshold, the UE is coupled to a power source and not equipped with a battery, an uplink transmission buffer size of the UE passes a fifth threshold, or the temperature of the UE is less than a sixth threshold; and
wherein transmitting the PPI comprises transmitting a PPI that is set to or indicates normal power mode.

25. The apparatus of claim 23, wherein the at least one processor determines the one or more operating conditions does not pass a threshold; and
wherein the transmitter transmits the PPI comprises transmitting a PPI that is set to or indicates low power mode.

26. The apparatus of claim 23, wherein the at least one processor is further configured to:
decide whether or not to delay sending a scheduling request (SR) to the eNB based, at least in part, on the determination.

27. A computer-readable medium for wireless communications having instructions stored thereon, the instructions executable by one or more processors for:
determining one or more operating conditions related to at least one of a throughput, battery configuration, application data history, or temperature of the UE; and
transmitting a power preference indication (PPI) to an evolved Node B (eNB) based, at least in part, on the determination.

28. The computer-readable medium of claim 27, wherein determining the one or more operating conditions comprises determining at least one of: a throughput of the UE passes a first threshold, an average number of scheduled resource blocks (RBs) per subframe of the UE passes a second threshold, a percentage of time the UE is scheduled passes a third threshold, application data history of the UE passes a fourth threshold, the UE is coupled to a power source and not equipped with a battery, an uplink transmission buffer size of the UE passes a fifth threshold, or the temperature of the UE is less than a sixth threshold; and
wherein transmitting the PPI comprises transmitting a PPI that is set to or indicates normal power mode.

29. The computer-readable medium of claim 27, wherein the one or more processors determine the one or more operating conditions does not pass a threshold; and
wherein the transmitting the PPI comprises transmitting a PPI that is set to or indicates low power mode.

30. The computer-readable medium of claim 27, further comprising instructions for:
deciding whether or not to delay sending a scheduling request (SR) to the eNB based, at least in part, on the determination.
